(19) United States
(12) Patent Application Publication
(10) Pub. No.: US 2007/0164600 A1
(43) Pub. Date: Jul. 19, 2007

(54) WHEEL RIM STRUCTURE

(76) Inventor: Shien-Yu Chiu, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/609,260

(22) Filed: Dec. 11, 2006

(30) Foreign Application Priority Data
Jan. 17, 2006 (TW) 095201063

(51) Int. Cl. B60B 7/04

(52) U.S. Cl. 301/37.25

(57) ABSTRACT

A wheel rim structure includes a wheel rim cover having an outwardly extending center rod, an axle bearing mounted on the center rod of the wheel rim cover, and a rotating member rotating member or pendulum-like weight mounted on the axle bearing and carrying an advertising panel. When a rotating member is used, it keeps rotating when the wheel rim is stopped with the wheel due to an inertia effect. When a pendulum-like weight is used, it is kept immovable during rotation of the wheel rim with the wheel.

### BACKGROUND OF THE INVENTION

1. Field of the Invention

The present invention relates to vehicle wheel rim structures and more particularly, to such a wheel rim structure, which has a rotating member or pendulum-like weight mounted on an axle bearing on an outer center rod of the wheel rim cover to show a visual advertising effect when the wheel rim is rotated and then stopped.

2. Description of the Related Art

A vehicle wheel uses a wheel rim to support the tire, and a wheel rim cover to cover the wheel rim. During rotation of the wheel, the wheel rim cover is rotated with the wheel rim. This design of wheel rim cover simply works to keep the wheel rim from sight without providing other functions for other purposes. There is known a wheel rim structure, which keeps the wheel rim cover immovable during rotation of the wheel. However, this wheel rim structure is complicated, requiring a specially designed axel bearing holder. Further, the wheel rim cover will keep rotating for a period when the wheel is stopped.

There is also known a wheel rim structure, which has a fixed mounting structure at the center of the wheel rim, a movable mounting structure mounted on the fixed mounting structure by means of axle bearing means, a wheel rim cover mounted on the movable mounting structure, and stop means mounted on the wheel rim cover or the movable mounting structure and adapted to stop rotation of the wheel rim cover relative to the wheel rim. This design keeps the wheel rim cover immovable relative to the wheel rim either the wheel is rotating or stopped. However, this complicated structure is difficult to mount and to dismount, and has a high manufacturing cost.

### SUMMARY OF THE INVENTION

The present invention has been accomplished under the circumstances in view. According to one embodiment of the present invention, the wheel rim structure comprises a wheel rim cover having an outwardly extending center rod, an axle bearing mounted on the center rod of the wheel rim cover, and a rotating member rotating member mounted on the axle bearing and carrying an advertising panel. The rotating member keeps rotating when the wheel is stopped due to an inertia effect.

According to an alternate form of the present invention, the wheel rim structure comprises a wheel rim cover having an outwardly extending center rod, an axle bearing mounted on the center rod of the wheel rim cover, and a pendulum-like weight mounted on the axle bearing and carrying an advertising panel. The pendulum-like weight is kept immovable during rotation of the wheel rim with the wheel.

### BRIEF DESCRIPTION OF THE DRAWINGS

FIG. 1 is an exploded view of a wheel rim structure according to the present invention.

FIG. 2 is an exploded view of an alternate form of the wheel rim structure according to the present invention.

FIG. 3 is a sectional assembly view of the wheel rim structure shown in FIG. 1.

FIG. 4 is a sectional assembly view of the wheel rim structure shown in FIG. 2.

### DETAILED DESCRIPTION OF THE PREFERRED EMBODIMENT

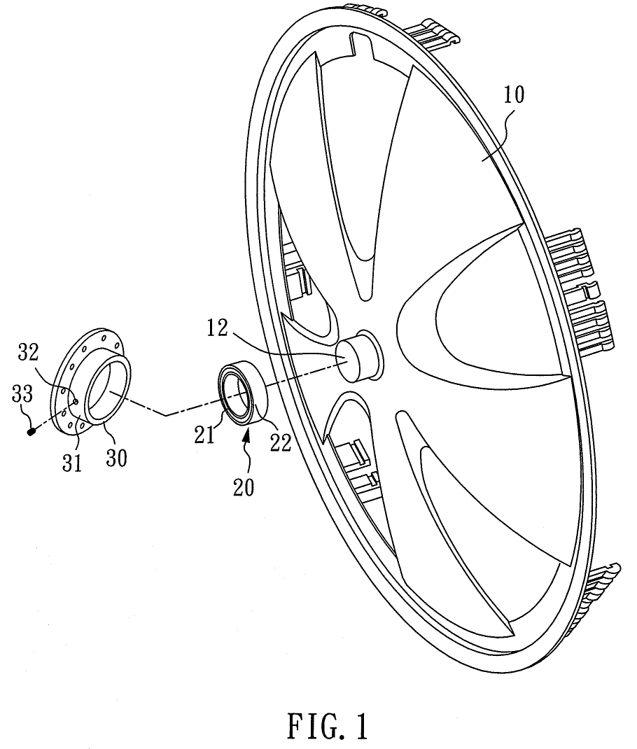

Referring to FIG. 1, a wheel rim structure in accordance with the present invention is shown comprised of a wheel rim for supporting a wheel (not shown) and a cover 10 covering the wheel rim. The cover 10 has a center rod 12 perpendicularly extending from the center of the outside wall thereof. The center rod 12 is formed integral with the cover 10. An axle bearing 20 is mounted on the center rod 12. The inner diameter 21 of the axle bearing 20 fits the outer diameter of the center rod 12. By means of the effect of the axle bearing 20, the cover 10 is rotatable.

Referring to FIG. 1 again, a rotating member 30 is mounted on the axle bearing 20. According to this embodiment, the rotating member 30 is a circular disk that can be mounted with an advertising panel of any of a variety of designs. The rotating member 30 has an annular coupling portion 31 perpendicularly extended from the backside thereof and capped on the axle bearing 20, a side screw hole 32 transversely cut through the peripheral wall of the annular coupling portion 31, and a tightening up screw 33 mounted in the side screw hole 32 and stopped against the outer diameter 22 of the axle bearing 20 to affix the rotating member 30 to the axle bearing 20.

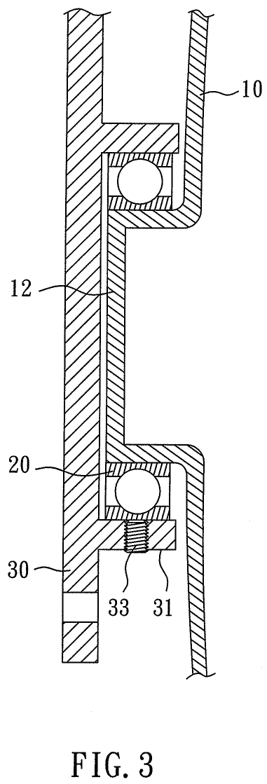

Referring to FIG. 3 and FIG. 1 again, when the wheel rim is rotated with the wheel, the cover 10 is rotated with the wheel rim, and the rotating member 30 is rotated with the axle bearing 20. At this time, the design of the advertising panel (not shown) of the rotating member 30 provides a rotating effect. When the wheel is stopped, the rotating member 30 keeps rotating for a period, providing a motion effect to attract people.

FIG. 1 shows an alternate form of the present invention. According to this embodiment, a weight 40 is mounted on the axle bearing 20. The weight 40 is a sector-like pendulum, having an annular coupling portion 31 perpendicularly extended from the backside of one end thereof and capped on the axle bearing 20, a side screw hole 32 transversely cut through the peripheral wall of the annular coupling portion 31, and a tightening up screw 33 mounted in the side screw hole 32 and stopped against the outer diameter 22 of the axle bearing 20 to affix the weight 40 to the axle bearing 20.

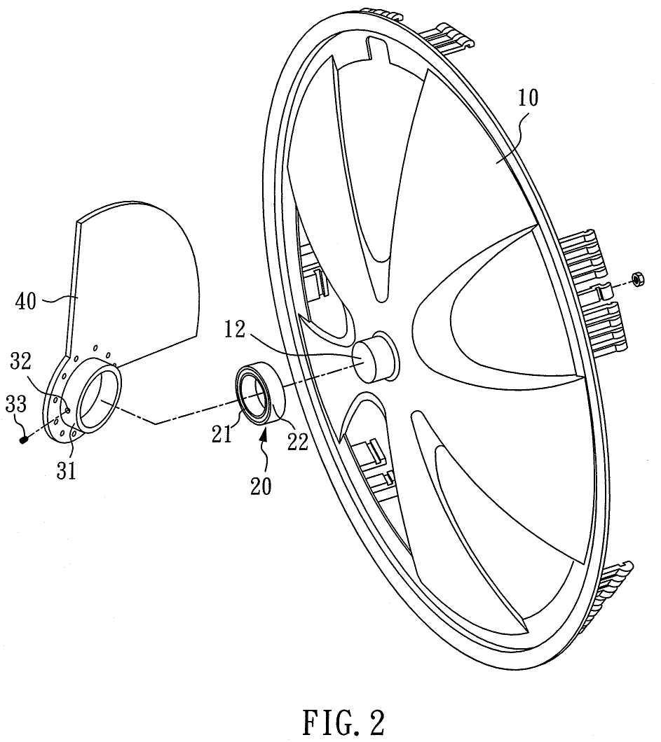

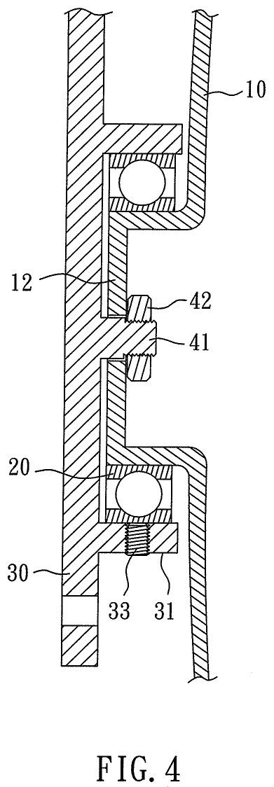

Referring to FIG. 4 and FIGS. 2 again, the weight 40 can be made having a backwardly extending screw rod 41, which is axially inserted through an axial center through hole (not shown) of the cover 10 and screwed up with a nut 42 to secure the weight 40 to the cover 10, allowing rotation of the cover 10 relative to the weight 40.

Referring to FIGS. 2 and 4 again, when the wheel rim is rotated with the wheel, the cover 10 is rotated with the wheel rim, however the weight 40 is kept immovable, and the advertising design carried on the weight 40 is visible.

A prototype of wheel rim structure has been constructed with the features of FIGS. 1˜4. The wheel rim structure functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A wheel rim structure comprising:
a wheel rim cover, said wheel rim cover having an outwardly extending center rod;
an axle bearing mounted on said center rod of said wheel rim cover; and
a rotating member mounted on and affixed to said axle bearing and rotatable with said axle bearing relative to said wheel rim cover, said rotating member carrying an advertising panel.

2. The wheel rim structure as claimed in claim 1, wherein said rotating member is a disc member.

3. A wheel rim structure comprising:
a wheel rim cover, said wheel rim cover having an outwardly extending center rod;
an axle bearing mounted on said center rod of said wheel rim cover; and
a weight mounted on and affixed to said axle bearing and rotatable with said axle bearing relative to said wheel rim cover, said weight carrying an advertising panel.

4. The wheel rim structure as claimed in claim 3, wherein said weight is a pendulum.
